(19) United States
(12) Patent Application Publication
(10) Pub. No.: US 2015/0193889 A1
(43) Pub. Date: Jul. 9, 2015

(54) DIGITAL CONTENT PUBLISHING GUIDANCE BASED ON TRENDING EMOTIONS

(71) Applicant: Adobe Systems Incorporated, San Jose, CA (US)

(72) Inventors: Mohit Garg, New Delhi (IN); Vineet Gupta, Uttar Pradesh (IN); Pawan Goyal, Uttar Pradesh (IN); Ankur Jain, Utter Pradesh (IN); Vivek Kumar, Uttar Pradesh (IN)

(73) Assignee: Adobe Systems Incorporated, San Jose, CA (US)

(21) Appl. No.: 14/151,300

(22) Filed: Jan. 9, 2014

(51) Int. Cl. G06Q 50/00; G06Q 30/02

(52) U.S. Cl. CPC G06Q 50/01; G06Q 30/0251

(57) ABSTRACT

A moderating system is disclosed for providing publishing guidance for proposed online content prior to publishing that content. The system is configured to, for a given post to be published and a target audience, automatically determine the topic of the post and compare the emotion associated with that post with the trending emotion associated with the target audience, for that particular topic. In one such embodiment, the comparison of the post emotion and the target audience emotion is accomplished by determining the similarity between two emotion histograms (one based on the post and one based on the target audience) using vector similarity measures and other suitable similarity estimation techniques. Each of the post emotion and the trending emotion within the target audience for the topic can be represented by multiple emotions (e.g., emotion pair based on Plutchik's emotion model, or other advanced emotion indicator).

### FIELD OF THE DISCLOSURE

This disclosure relates to digital content publishing, and more particularly, to techniques for client-side moderating of digital content publishing based on trending emotions.

### BACKGROUND

Online social media generally refers to Internet-based applications that allow individuals and so-called online communities to create, exchange, modify, and/or discuss user-generated content. The extension of social media applications to mobile computing devices effectively enables highly interactive media platforms through which communications can reach large numbers of potentially interested persons in a rapid fashion, thereby making social media applications a dominant media outlet. The online social networks that are generated through the use of such social media applications have grown to be particularly important to marketers, whether they be selling products, services, or personal image (e.g., celebrities and so-called online personas). For example, it is not uncommon for marketers to make announcements, run promotions and interact with consumers using such applications. Social networking services, such as Facebook and Twitter, are particularly important to marketers and advertising entities, and as a result, such networks frequently play an important role in modern marketing campaigns. Indeed, marketers often devote substantial resources to influencing and monitoring consumer sentiment across social networks.

### BRIEF DESCRIPTION OF THE DRAWINGS

FIG. 1 illustrates an architecture for a communication network configured in accordance with an embodiment of the present invention.

FIG. 2 illustrates example input and output of a client-side post moderating module, in accordance with an embodiment of the present invention.

FIG. 3 is a block diagram of a client-side post moderating module configured in accordance with an embodiment of the present invention.

FIG. 4 illustrates a client-side post moderating methodology configured in accordance with an embodiment of the present invention.

FIG. 5a illustrates a specific example processing flow for carrying out the moderating methodology of FIG. 4, in accordance with an embodiment of the present invention.

FIGS. 5b-5f collectively illustrate another specific example processing flow for carrying out the moderating methodology of FIG. 4, in accordance with an embodiment of the present invention.

FIGS. 6a-b illustrate a client-side user interface configured for use with a post moderating methodology, in accordance with an embodiment of the present invention.

FIG. 7 illustrates a client-side user interface configured for use with a post moderating methodology, in accordance with another embodiment of the present invention.

FIG. 8a illustrates a table showing Plutchik's primary emotions.

FIG. 8b illustrates a table showing Plutchik's advanced emotions.

FIG. 8c illustrates Plutchik's wheel of emotions annotated with various emotion-indicating icons.

FIG. 9 illustrates a matching table configured, in accordance with an embodiment of the present invention.

### DETAILED DESCRIPTION

Techniques are disclosed for providing publishing guidance to a user with respect to proposed social media posts and other digital content to be published, based on trending emotions associated with a given target audience. The techniques can be implemented on a user's computer system or the so-called client-side of a given communication network platform. The techniques generally include the use of emotion analysis of proposed content for publishing to determine how well that content would engage with trending emotion of the target audience. The communication network platform may be, for example, a social media network or blog or any other digital publishing outlet. One example embodiment includes a moderating system for providing publishing recommendations for proposed social media posts, commentary or other digital content (e.g., Facebook posts, Twitter Tweets, blog posts, trending news posts, video uploads, photo uploads, all generally referred to herein as ‘posts’) prior to the publishing of that content. The system is configured to, for a given post to be published and a given target audience, automatically determine the topic of the post and compare the emotion associated with that post with the trending emotion associated with the target audience, for that particular topic. Based on the comparison, the system can then recommend to the user whether or not to proceed with publishing that content. So, pre-post publishing guidance that is rooted in trending emotion of the target audience is provided to the would-be publisher.

General Overview

As previously indicated, marketers often devote substantial resources to influencing and monitoring consumer sentiment across social networks. While some solutions may inform marketers about the emotions of current trending topics, the emotion analysis is reactive in that it is based on information already available to the consuming public. To this end, there is currently no mechanism to apply emotion analysis to the content creation and publishing workflow (prior to posting). Some existing solutions around publishing do take into account the sentiment of the post. However, sentiment is not only an inadequate indicator of the audience emotion on a given topic, it also does not provide enough information to enable marketers to improve their message. For example, both angry and sad conversations would merely be classified as a negative sentiment but would further need very different messaging in order to resonate with the audience. In this sense, sentiment is too coarse. In particular, sentiment merely refers to the polarity in textual content (it is simply one of positive, negative, or neutral) and does not differentiate between various human emotions. For instance, each emotion of admiration, happiness, love, and anticipation reflects a positive sentiment, while each emotion of contempt, sadness, hatred, and boredom reflects a negative sentiment. Further exacerbating the problem is that sentiment cannot be used to disambiguate emotions that may carry more than one polarity (e.g., emotion of surprise can be negative, positive, or neutral, depending on the context of the given situation).

Thus, and in accordance with an embodiment of the present invention, a client-side moderating system configured to make publishing recommendations for proposed social media posts and other postable digital content is provided herein. As will be appreciated, the disclosed techniques can be used to provide marketers a way to create content and maximize alignment with trending user emotions around a given topic, prior to publishing. As will further be appreciated, a marketer can be anyone or any entity interested in publishing content. It is typically desirable that the published content is favorably received by a given target audience, whether that marketer is providing goods/services (e.g., commercial entities), information (e.g., news organizations, commentators, or individuals that may wish to publish digital content), and professional image (e.g., politicians, comedians, celebrities). The marketer can also be anyone who may benefit from having a well-regarded or otherwise followed online presence.

In some example scenarios, given a social media post to be published and the target segment (i.e., target audience) for that post, the system will automatically determine the topic and keywords in the post. An emotion analysis can then be performed on that proposed post based on the detected topic and keywords, thereby providing a first emotion indicator (generally referred to herein as the post emotion). The system will then determine the trending emotion for the given topic and keywords in the target segment or audience, thereby providing a second emotion indicator (generally referred to herein as the trending emotion within the target audience). The system can then assess similarity between these two emotion indicators and recommend whether to post or not. In one such embodiment, the comparison of the post emotion and the trending emotion within the target audience is accomplished by determining the similarity between two emotion histograms (one histogram based on the post emotion and the other histogram based on the trending emotion within the target audience) using vector similarity measures such as cosine similarity and other suitable similarity estimation techniques. Numerous variations and configurations, as well as numerous publishing applications, will be apparent in light of this disclosure.

A target audience, in addition to its plain and ordinary meaning, generally refers herein to one or more persons or groups or organizations or combinations thereof that a marketer is attempting to reach with one or more posts. In a more general sense, a target audience refers to any such entities that may be interested in given content. A post, in addition to its plain and ordinary meaning, generally refers herein to any digital communication that can be electronically published to an online network or location. The post may include textual content, graphical content, photo content, video content, or any combination thereof. In a more general sense, a post may include any digital content that can be published. A post may also include, for example, content in a physical form (e.g., paper, film, photograph, etc) that has been electronically analyzed as provided herein. Published content, in addition to its plain and ordinary meaning, generally refers herein to content that is accessible to one or more persons other than the person that created that content. A marketer, in addition to its plain and ordinary meaning, generally refers herein to any person, group, organization, or combinations thereof that wish to publish content.

So, pre-post publishing guidance that is rooted in trending emotion of the target audience is provided to the would-be publisher. Such guidance may be useful, for example, to a marketer wishing to positively connect with or otherwise impact a target audience having a measurable trending emotion. In some embodiments, an automatic recommendation with respect to a proposed post saves time and resources of the marketer. A post recommended for publishing is more likely to resonate or influence the target audience, given the post's pre-publication assessment based on currently trending emotion of that target audience. Numerous benefits will be apparent in light of this disclosure.

System Architecture

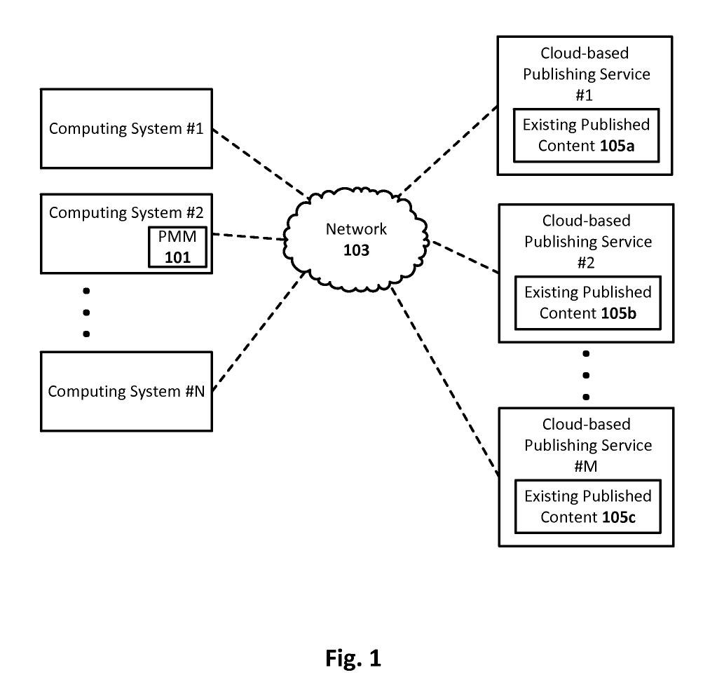

FIG. 1 illustrates an architecture for a communication network configured in accordance with an embodiment of the present invention. As can be seen, the architecture includes a number of computing systems (#1 through #N) each capable of operatively coupling to a number of cloud-based publishing services (#1 through #M) via a communication network 103. Each of the publishing services includes or otherwise provides access to an existing corpus or body of published content (105a, 105b, 105c, etc). In operation, a given user can use a corresponding one of the N computing systems to access any one or more of the M publishing services and post digital content to that system(s). As can be further seen, computing system #2 includes a post moderating module (PMM) 101, which is programmed or otherwise configured to assist the user in making publishing decisions in accordance with an embodiment of the present invention. In particular, the user of computing system #2 can receive, via the PMM 101, recommendations on whether or not to publish a proposed post, based on the trending emotion of the target audience for the topic captured in that proposed post. The post may include, for example, text, a photo, video, or some combination. Non-textual content contained in photos or video can be extracted using conventional image processing and sound-to-text translators to create an appropriate text string that can then be processed in a similar manner to text-based posts.

The publishing services may be, for example, any one or combination of social media applications (e.g., Facebook, Twitter, Instagram, LinkedIn, Tumblr, Flipboard, etc), blogs and information boards and news sites (e.g., HuffingtonPost, Mashable, Gawker, Businesslnsider, The Daily Beast, CNN, etc), video upload sites (e.g., YouTube, MySpace videos, DailyMotion, MetaCafe, iPikz, etc) or any other systems that allow for publishing and viewing of digital content. The existing published content 105 of each publishing system may include any type of digital content such as, for example, user generated content, news stories, articles, photos, and/or videos, and is accessible for consumption by other users having access to that publishing system. As will be further appreciated, the network 103 can be any communication network or combination of networks (whether public and/or private, wired and/or wireless), such as a user's local area network and/or the Internet as is frequently the case, or a campus-wide network for a university or business. Each cloud-based publishing system may be implemented with any suitable type of architecture, and may include one or more servers under the control of one or more entities (e.g., a single server, a server farm, multiple server farms, etc). Numerous configurations that allow for publication of user generated digital content can be used and the claimed invention is not intended to be limited to any particular server system or back-end configuration.

The computing systems can be implemented with any typical computing technology, such as a desktop, laptop, work station, tablet, smart phone, smart camera, or other computing system than allows for generation of user content and is capable of posting that content to a publishing service via a network. Such computing systems will generally include one or more processors capable of executing software modules stored in one or more memories accessible by that processor(s), or other functional componentry that is configured to carry out typical computing system functionality. In addition, and as will be appreciated in light of this disclosure, any such systems can be programmed or otherwise configured with a PMM 101 to carry out pre-post moderating functionality as provided herein. While a plurality of both computing systems and publishing services are shown in the example embodiment of FIG. 1, other embodiments may include, for example, only one of each, or multiple computing systems capable of operatively coupling to a single publishing service, or a single computing system capable of operatively coupling to multiple publishing service services. Further note that only one post moderating module 101 is shown in the example embodiment depicted in FIG. 1, but any number of the N computing systems may be programmed or otherwise configured with a PMM 101.

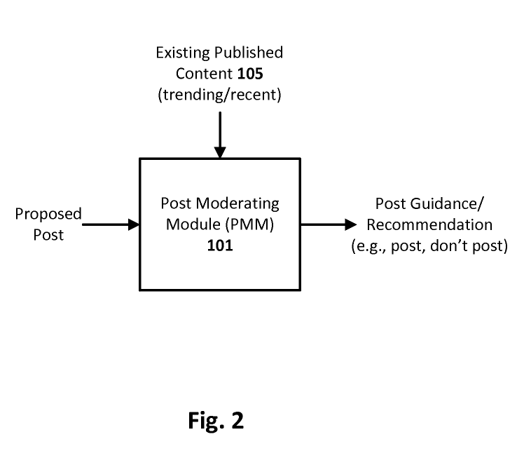

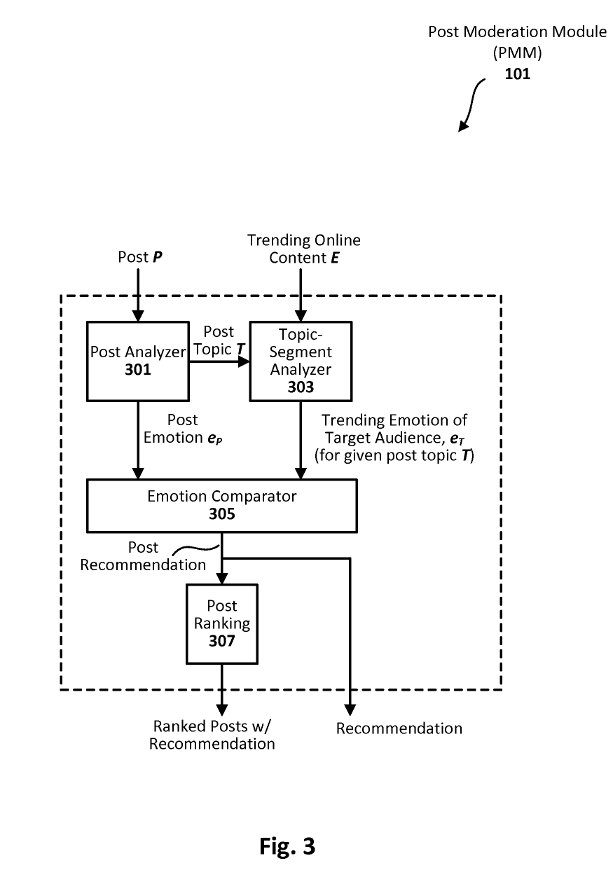

FIG. 2 illustrates example input and output of a client-side post moderating module 101, in accordance with an embodiment of the present invention. As can be seen, the PMM 101 is configured to receive a proposed post, which generally refers to some user generated content (e.g., an article or news story or a link thereto, an advertisement or a link thereto, a Twitter Tweet, a Facebook post, a blog post, a video, a photo, or any other digital content to be published). In addition, the PMM 101 is further configured to access and capture or otherwise receive existing published content 105 associated with a given target audience, and in particular, the more recent or so-called trending content within that audience. The PMM 101 is further configured to determine the emotion captured in the proposed post, and to compare that emotion with the trending emotion captured in the target audience with respect to the topic of the proposed post. Based on the results of that comparison, the PMM 101 is further configured to provide the would-be publisher/user publishing guidance or a recommendation. Further details of the PMM 101 will be discussed with reference to FIGS. 3-9.

In general, a topic refers to subject matter dealt with in any media and may be presented, for instance, in text, photos, video, discourse, conversation, or combinations thereof. To this end, trending content may refer to a topic or subject matter that is the latest “buzz” or information of interest to a given audience, and therefore is referenced by that audience at a relatively high frequency (e.g., as compared to the frequency at which other topics are referenced by that audience, when considered on a normalized scale). In addition, or alternatively, a trending topic may also be identified by so-called content velocity, which generally indicates acceleration in the number of interested parties in a given topic. So, for instance, as a given topic begins to favorably trend and “catch-on” with a given target audience, the number of posts related to that given topic may continuously increase over a relatively short period of time, thereby indicating an increase in velocity (or acceleration). There are numerous known trend-tracking techniques and any such techniques can be used to assess trends developing in the existing published content 105 or other data corpus, as will be appreciated in light of this disclosure.

As will be further appreciated in light of this disclosure, the existing published content 105 is typically associated with or otherwise provided in the context of a given audience, which effectively provides the target audience of anyone considering publishing content into that existing body of work. For instance, a blog about poetry would be frequented by people interested in poetry whom collectively provide the target audience of anyone posting to that blog. Similarly, an online social network of a given user typically includes friends, family, acquaintances, and/or so-called followers/friends/contacts of that user, which effectively provides a target audience for that user. Similarly, an online technology network (e.g., Institute of Electrical and Electronics Engineers, American Society of Civil Engineers, etc) where scientists or engineers can publish white papers, presentations, and other technical papers would be frequented by people interested in a given area of technology who collectively provide the target audience of anyone posting to that network. In a more general sense, any online network or community typically includes a number of subscribers, followers, and/or other persons that have indicated in one way or another an interest in subject matter associated with that community and collectively provides a target audience for future posters that wish to publish content to that network/community.

In some embodiments, the PMM 101 can be configured to crawl the relevant storage location(s) where the existing published content 105 is located, and to cull the information stored therein to the existing published content 105 relative to a given topic represented in a proposed post. In other embodiments, the existing published content 105 relative to a given topic can be harvested and organized by topic by a third-party and then provided to the PMM 101 in a desired format, such as by a server-side trending topic analyzer and reporting tool. In any such cases, the collection of existing published content 105 can be accomplished using any number of conventional or customized data harvesting and topic-based aggregation techniques, and the claimed invention is not intended to be limited to any particular such technique or set of techniques. Once the existing published content 105 for a given topic is collected or otherwise made accessible, the PMM 101 can then assess that content to determine trending emotion within that existing content 105.

Post Moderating Module

FIG. 3 is a block diagram of a client-side post moderating module 101 configured in accordance with an embodiment of the present invention. As can be seen, the PMM 101 is configured with a number of sub-modules or components, including a post analyzer 301, a topic-segment analyzer 303, an emotion comparator 305, and an optional post ranking module 307. Other embodiments may include a different degree of integration or modularity, and the example depicted is provided to facilitate discussion and not intended to limit the functionality provided herein to a particular architecture. For instance, in other embodiments, the post analyzer 301 and the topic-segment analyzer 303 may be integrated into a common module that provides comparable functionality. Numerous other configurations will be apparent in light of this disclosure.

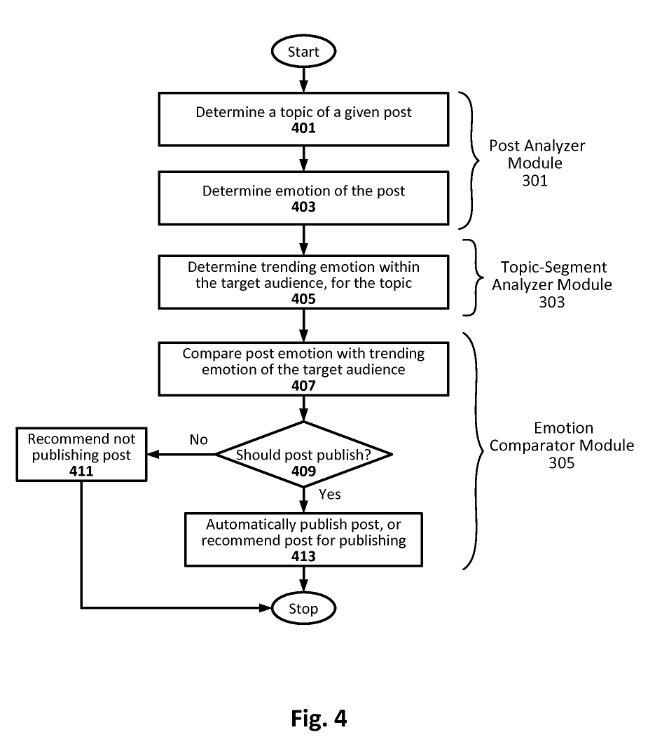

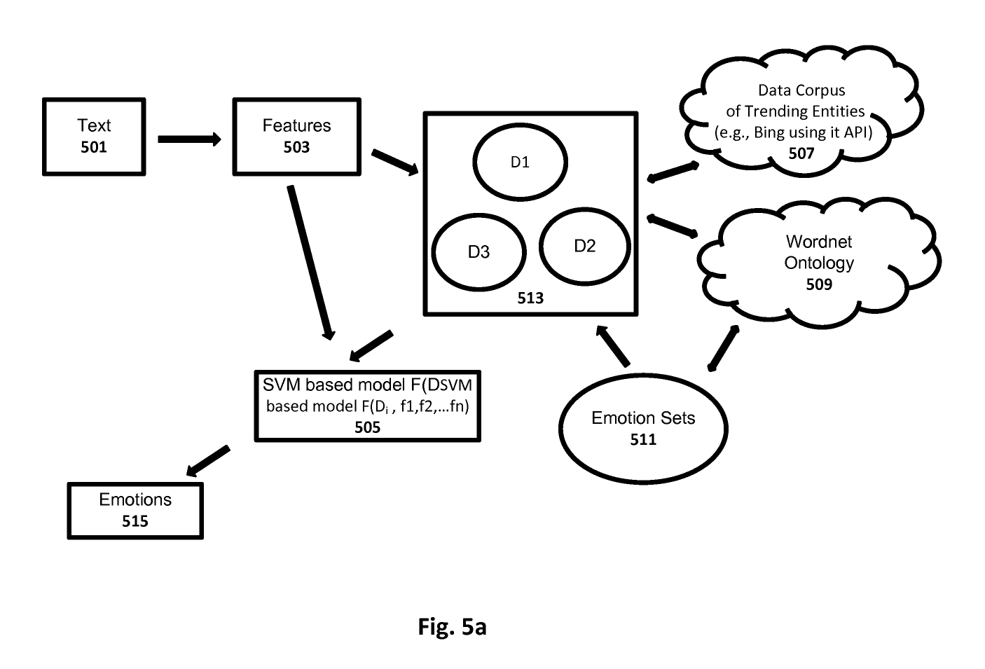

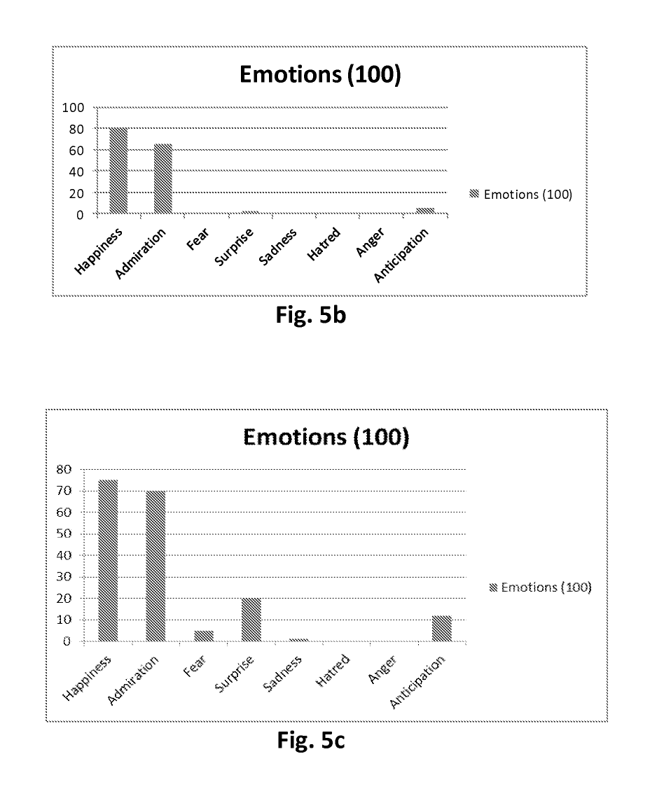

In operation, the post analyzer 301 is programmed or otherwise configured to receive a proposed post, and to determine both the topic (7) and emotion (e_{P}) associated with that post. The topic-segment analyzer 303 is programmed or otherwise configured to receive the post topic T along with the trending online content indicated in the existing published content 105, and to determine the trending emotion (e_{T}) within the target audience associated with that post topic T. The emotion comparator 305 receives each of the post emotion e_{P} and the trending emotion e_{T} of the target audience, and is programmed or otherwise configured to determine how closely the post emotion e_{P} matches the trending emotion e_{T} of the target audience. Once the degree of matching or closeness is determined, the emotion comparator 305 is further configured to output publishing guidance to the user based on that determination, which might include, for example, a recommendation (e.g., publish or don't publish or consider modifying, etc). In some embodiments, the user can provide multiple variations of a proposed post, or simply a plurality of different proposed posts, and the post ranking module 307 can be configured to rank those various proposed posts based on the degree of similarity in the post emotion e_{P} to the trending emotion e_{T} of the target audience. The rankings can then be provided to the user along with any recommendation (e.g., top three ranked posts are green-lighted for publishing; hold off on publishing other lower ranked posts). Further details of how these functional modules operate and how they can be implemented in some example embodiments will be provided with reference to FIGS. 4 and 5a-f.

Each of the various components can be implemented in software, such as a set of instructions (e.g., C, C++, object-oriented C, JavaScript, Java, BASIC, etc) encoded on any computer readable medium or computer program product (e.g., hard drive, server, disc, or other suitable non-transient memory or set of memories), that when executed by one or more processors, cause the various pre-post guidance methodologies provided herein to be carried out. In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the pre-post guidance functionality described herein. In a more general sense, any suitable combination of hardware, software, and firmware can be used.

In one example embodiment, each of the post analyzer 301, topic-segment analyzer 303, emotion comparator 305, and optional post ranking module 307 is implemented with JavaScript or other downloadable code that can be provisioned in real-time to a client requesting access (via a browser) to an application server hosting the online publishing venue of interest. In another example embodiment, each of the post analyzer 301, topic-segment analyzer 303, emotion comparator 305, and optional post ranking module 307 are installed locally on the user's computing system, as a pre-post guidance or moderating system. In still another embodiment, the PMM 101 can be partly implemented on client-side and partly on the server-side. For example, each of the post analyzer 301, topic-segment analyzer 303, emotion comparator 305, and optional post ranking module 307 can be implemented on the server-side (such as a server that provides access to, for instance, Adobe Social or a cloud-based marketing application), and a user interface (such as Adobe Social user interface or other suitable user interface) can be implemented on the client-side. Numerous such client-server arrangements will be apparent in light of this disclosure.

As will be further appreciated, the PMM 101 can be offered together with a given application (such as integrated with a social networking application or user interface, or with any application that allows for online publishing of digital content), or separately as a stand-alone module (e.g., plugin or downloadable app, such as a Facebook or Twitter Plugin or a smartphone app from the Apple store, or other code) that can be installed on a user's computing system to effectively operate as a gateway to outgoing posts for a given application or a user-defined set of applications or for all outgoing posts. Alternatively, the PMM 101 could be hosted as an online cloud-based service integrating any available third-party trending topic and content ideation solution. Numerous embodiments and specific configurations will be apparent in light of this disclosure.

In one specific example embodiment, for instance, the PMM 101 is integrated with the publishing block of the Adobe Social application provided by Adobe Systems Incorporated. In general, Adobe Social enables marketers to use social media data as an input to optimize interactions with their customers and prospects across all channels to achieve measurable business results. In one specific aspect, Adobe Social allows a marketer or user to publish posts to dozens or hundreds of social media pages in a relatively easy manner. In addition, Adobe Social allows custom audiences to be targeted based on, for example, demographic and geographic data to get the right text posts, images, videos, links, pictures and events to the right people at the right time. To this end, the PMM 101 could be used as part of the vetting or approval process that is implemented within the Adobe Social platform between the post creation process and the post publication scheduling process, in accordance with one such embodiment of the present invention.

Methodology

FIG. 4 illustrates a client-side post moderating methodology configured in accordance with an embodiment of the present invention. As can be seen, the methodology can be carried out by the PMM 101 discussed with reference to FIG. 3, and the flow chart is annotated with the modules/components that can carry out each part of the flow. However, other embodiments may carry out the methodology using a different structure but still provide overall similar functionality.

Upon receiving a proposed post for publishing, the method includes determining 401 a topic of that post. The post analyzer module 301 can carry out this function, or some other module(s). In more detail, let the proposed post to be published be denoted by P. Further assume the proposed post comprises textual content, a photo, a video, or some combination thereof. In addition, let P_{target} denote the audience targeting parameters for post P. Note that for pictures and video, a preliminary information extraction process can be carried out using, for instance, optical character recognition (OCR) and/or other conventional image processing techniques to extract information captured in the photo or video frames, including text and other detectable information in the images that can be translated into corresponding textual content. In addition, speech and sounds can be extracted from audio and video files and converted to text. With the textual content available for analysis (whether that text was provided originally in textual format or derived from image processing and/or sound-to-text analysis), any suitable keyword extraction algorithms can then be used to determine the keywords of the topic being discussed in post P. Example keyword extraction algorithms that can be used include the term frequency-inverse document frequency (TF-IDF) algorithm, the keyphrase extraction algorithm (KEA), and the Maui Indexer, to name a few. These keywords can then be mapped to a given ontology, using any suitable ontological classification algorithms to determine the ontological classification of the topic being discussed in post P. As is known, an ontology is a description of things-of-interest generally referred to as concepts along with information about the relationships between those concepts and properties which the concepts have. Each concept can be associated with a topic and action. To this end, an ontology differs from a simple taxonomy in that it allows for the addition of constraints to taxonomy and further allows for the performance of inferences with concepts. One example ontology is based on WordNet, but other lexical databases could be used as well. So, with the operation at 401, the natural language of the proposed posts is analyzed and chunked into phrases which are then mapped to concepts in the ontology. If a given chunk (extracted keyword/phrase) can refer to more than one concept then the user may be prompted with questions to assist in disambiguating that chunk. An action can be assigned to each concept in the ontology, which in accordance with an embodiment of the present invention is the assigning of an emotion (e.g., based on Plutchik's emotion model, or any other suitable emotion analysis models), as will be discussed in turn. Let the resulting set of keywords and ontological tree be denoted by T (generally, for topic).

The method continues with determining 403 an emotion of the post P. In one such embodiment, this is accomplished by determining the emotion histogram e_{P} of the post P using an emotion measurement algorithm based on Plutchik's emotions. In more detail, and with reference to example process flow of FIG. 5a, given the textual content 501 of a proposed post, several elements present in that text are considered as features 503 for computing emotion content in that text 501. These features 503 may include, for instance, bag-of-words based TF-IDF features, bigrams, trigrams, n-grams, linguistic phrases, and/or other such natural language chunks determined at 401. As indicated at 513, three additional distance-based features (D1, D2, and D3) can be computed or otherwise derived from the text 501 using at least some of these textual features 503, so as to find the distance between text and each emotion in the proposed post. A number of suitable algorithms to extract distance based features for identifying emotions in texts will be apparent in light of this disclosure. For example, and in accordance with an embodiment of the present invention, given a word or phrase, it can be computed how close that word or phrase is from another word or phrase in terms of meaning by using any of the following approaches. A first approach includes evaluating how closely they occur in social conversations (e.g., a word like “happy” would occur more frequently with words like “joy” or “fun” as opposed to words like “sad” and “angry”). This co-occurrence based metric is called PMI (pointwise mutual information). A second approach includes how close they are in a word-graph (a graph in which words which are closer in meaning occur closely). WordNet is an example of one such graph. A third approach includes evaluating the overlap between the synonym set of first word with that of the second word. These approaches all allow for computing the distance measure between two text elements. For one specific example, consider the following proposed post: “I am very happy with my company.” In this example case, “very happy” would have a smaller distance (as defined by one of the three approaches) with the seed-set of “Happiness” (synonym of joy) as compared to that of “Sadness.” Hence, this post will have a stronger indication towards emotion of “Happiness” as compared to that of “Sadness.” As will be further appreciated in light of this disclosure, the emotion histogram e_{P} of the post P can also be denoted as an emotion vector Eₚ (e.g., a plurality of bits, each bit corresponding to a particular emotion, such as designated emotions of a given emotion model).

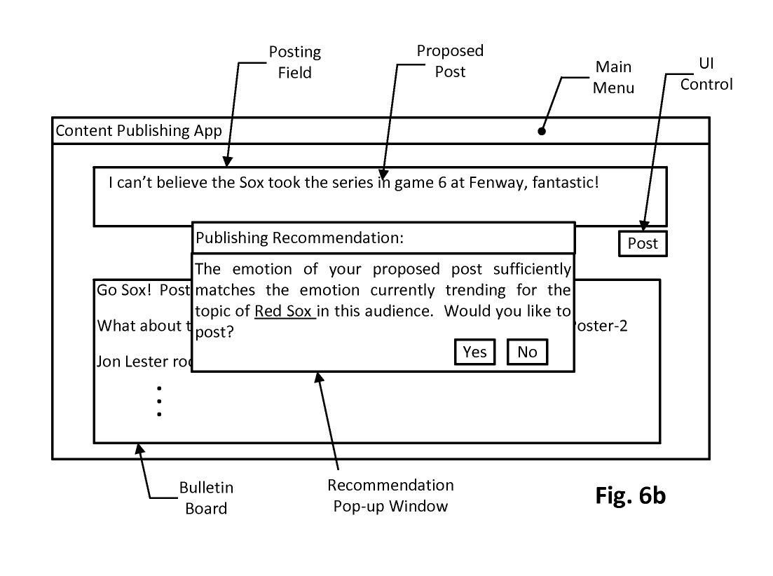

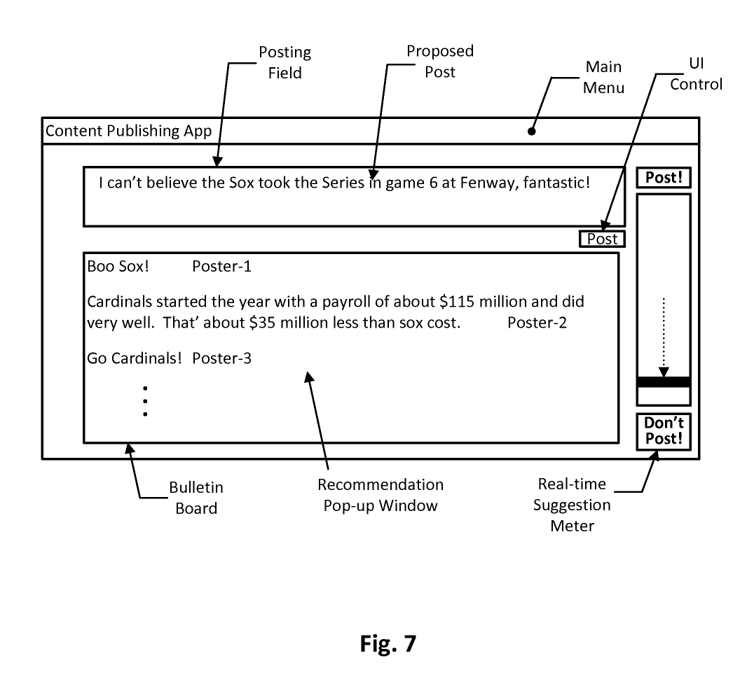

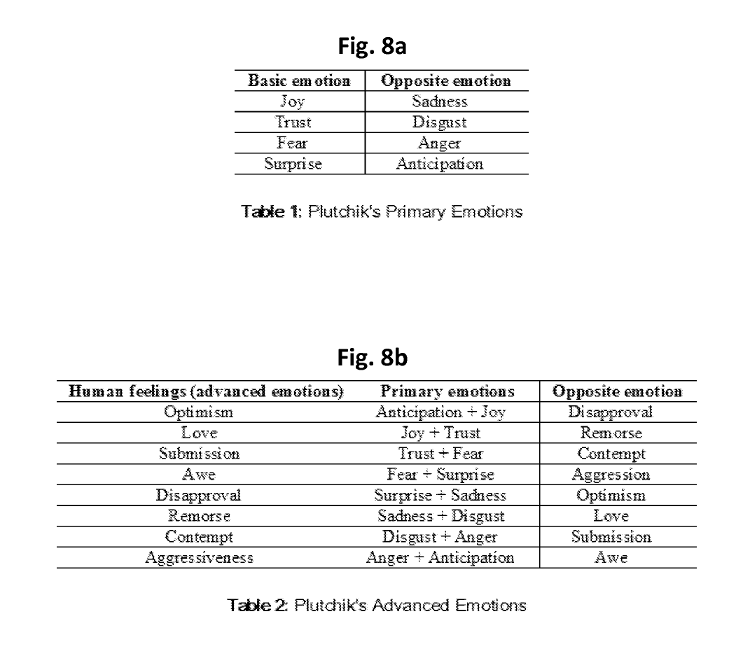

In more detail, and with further reference to FIG. 5a, let distance D1 refer to pointwise mutual information (PMI) content (first approach), which may be computed as:

$$pwM 1 ( p , w ) = {log}_{2} ( \frac{P ( p , w )}{P ( p ) \cdot P ( w )} ) ,$$

where p=phrases (bigrams, trigrams, linguistic phrases); w=word in an emotion seedset (e.g., Happy); and P(a, b, c, . . . )=probability of occurrence of a, b, c, . . . together in social conversations. In addition, let distance D2 refer to word-ontology distance (second approach), which in one example embodiment may be computed based a graph based similarity measure by Wu and Palmer (1994), or so-called WP-similarity, as:

$$WP - similarity = 2 * \frac{depth ( lcs )}{( depth ( s 1 ) + depth ( s 2 ) )} ,$$

where s1=synonym-set of first word; s2=synonym-set of second word; and lcs=least common subsumer of s1 and s2 in WordNet graph. Let distance D3 refer to class-overlap (third approach), which may be computed as:

$$P ( {e}_{i} \vert {x}_{j} ) = \frac{\vert {ℤ}_{j} ⋂ {ℂ}_{{e}_{i}} \vert}{{\sum }_{k = 1}^{8} \vert {ℤ}_{j} ⋂ {ℂ}_{{e}_{k}} \vert} ,$$

where P=probability that the emotion is eᵢ, given that the word is xⱼ; Zⱼ=synonym-set for word xⱼ; Ceᵢ=seed-set for emotion eᵢ; and Ceₖ=seed-set for emotion eⱼ. In operation, each of the emotion-features can be assigned coordinates in the given text, and each of the emotion-set words 511 can be assigned coordinates in the corresponding emotion-classes of WordNet ontology 509. The distance between these coordinates can be used as a measure of intensity of emotion represented in the proposed post. So, these distances are between words and seed-sets, phrases and seed-sets and bigrams-trigrams with seed-sets. After doing this for all the emotions, a support vector machine (SVM) based learning model is built at 505 for each of the emotions 515 to score the text on that emotion. In one specific embodiment, this score is output in a vector of eight bits, each bit corresponding to one of the eight primary or so-called basic emotions shown in Table 1 of FIG. 8a, which is based on Plutchik's model of emotions (Robert Plutchik, 1980). Note that a similar emotion analysis process can be performed on existing posts included in the already published data corpus of trending entities 507, as will be further explained in turn.

As will be appreciated, emotion analysis can be used to identify the granular human emotions from conversations, as such analysis considers human emotions at several levels—primary/secondary/tertiary. And all the emotions at a higher level can be broken down into their primary components. For example, and with further reference to Plutchik's model, higher level or so-called advanced emotions are shown in Table 2 of FIG. 8b, each composed of two basic or primary emotions. So, for instance, the advanced emotion of optimism is composed of the primary or basic emotions of anticipation and joy. As can be further seen, the opposite emotion of optimism is disapproval. The corresponding primary emotion-pair and the opposite advanced emotion are also shown for each of the advanced emotions of love, submission, awe, disapproval, remorse, contempt, and aggressiveness.

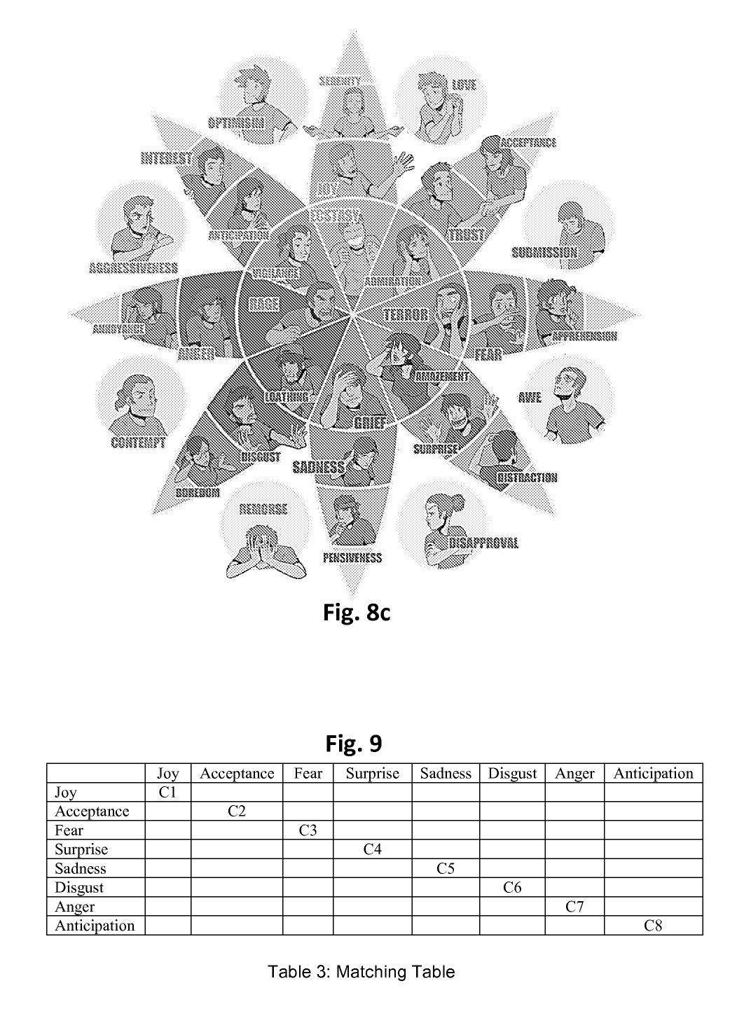

The details of Tables 1 and 2 (FIGS. 8a and 8b, respectively) are further illustrated via FIG. 8c, which illustrates Plutchik's wheel of emotions annotated with various emotion-indicating icons, and further illustrates the complexity of emotion analysis over mere sentiment indicators. As can be seen, Plutchik's wheel shows eight bipolar primary or base emotions: joy versus sadness; anger versus fear; trust versus disgust; and surprise versus anticipation. Secondary emotions are shown extending outwardly in the wheel's perimeter, and tertiary emotions are noted in the center of the wheel (note that secondary and tertiary are merely used in this particular context as labels and not intended to implicate an order-based limitation). Likewise, eight advanced emotions (optimism, love, submission, . . . , aggressiveness) are shown between the spokes of the wheel. In any such cases, note how opposing emotions are located directly opposite from each other in the wheel layout. For example, the advanced emotion of contempt is opposite the advance emotion of submission; the primary or base emotion of joy is opposite the primary/base emotion of sadness; the secondary emotion of serenity is opposite the secondary emotion of pensiveness; and the tertiary emotion of ecstasy is opposite the tertiary emotion of grief. Numerous other emotion relationships are similarly depicted by the wheel layout for each of the other advanced emotions and primary emotions and their corresponding secondary and tertiary emotions. Further note how Plutchik's model layout correlates or otherwise co-locates an emotion circle location with a color wheel location. To this end, each of the depicted emotions can be expressed at different intensities and can mix with one another to form different emotions, much like colors, so as to provide quantifiable values for emotions at base and advanced levels. Such quantification can be used in the matching process, as will be discussed in turn (see, for example, Table 3 of FIG. 9). Other emotion model structures can be used as well (e.g., W. Parrott's tree-structured list of emotions, which relates primary, secondary and tertiary emotions, and the techniques disclosed herein can use any such emotion models as will be appreciated in light of this disclosure.

With further reference to FIG. 4, the method continues with determining 405 the trending emotion within the target audience P_{target}, for the topic T. This can be assessed based on the data corpus of trending entities 507 (from which is derived existing published content 105 in FIG. 1), which in one example embodiment can be harvested by an application programming interface (API) associated with a search engine, such as Microsoft Bing, Google Search, or Yahoo! Search, or any other suitable search technology. In some embodiments, the determination of trending emotion captured in that data corpus 507 can be accomplished, for example, using the topic-segment analyzer 303 or other trending topic analyzer configured to function as will now be described. For purposes of discussion, define an entity as a node which could possibly be shared or talked about on the Internet including but not limited to social media posts (e.g., articles, blog posts, social media conversations, commentary, photos, videos, are all examples of entities, as that term is used in this context). Given a set of trending entities E, and the ontological classification for each element of the set E (based on WordNet or other suitable ontology-basis), assume these segmented trending entities are combined into trending topics based on the ontological classification. Further segment the trending entities based on any available audience segmentation. This could be, for example, demographic, interest-based, psychographic, or any other suitable segmentation. Now, derive an emotion histogram for each element of the set E using the algorithm used to analyze the proposed post emotion, and assign the emotion histogram to each segmented trending topic based on the emotion classification of each trending entity (assigned by mapping into the ontology). Let this set of segmented trending topics and emotion be denoted by S. Thus, given a trending topic and a given target audience segment, a distribution of the various emotions with which the topic is being discussed are obtained. The trending emotion of T within P_{target} can now be determined through a search in the set of previously calculated segmented trending topics S. Let the emotion histogram of the segmented trending topic found using the search above be denoted by e_{T}. This emotion histogram e_{T} of the segmented trending topic can be denoted as an emotion vector Eₜ, in a similar fashion as previously explained with the emotion histogram e_{P} of the post P being denoted as an emotion vector Eₚ.

The method continues with comparing 407 the post emotion with trending emotion of the target audience. In one embodiment, this is accomplished measuring the similarity between emotion-vector of the segmented trending Eₜ and the emotion vector of the post Eₚ by finding any similarity measure (e.g., standard cosine similarity) between these two vectors and used to determine whether there is a good match between the two. A threshold could be used to recommend publishing the post or modifying the content. One example similarity measure computation is shown here:

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}}$$

where A=emotion-vector for trending posts; B=emotion-vector for composed post; n=number of emotions (which in one example embodiment are Plutchik's eight primary emotions); and i is an index that varies from 1 to n. In another example embodiment, a matching table can be used that is based on the emotion classification algorithm selected above for the Plutchik's emotions. As used herein, matching table represents the extent of overlap (similarity) of post-emotions with trending emotions. For instance, say the overlap varies from 0 to 1 (i.e., perfect match of emotion level to no match), then this overlap result can be color coded with red to represent no-match or green to represent a perfect match (in a continuous gradient from red to green representing 0 to 1). In one such embodiment, the matching table may look something like the following Table 3 of FIG. 9, where each color (C1, C2, . . . , C8) represents the extent of the match for each Plutchik's emotion between the post and segmented trending topic. One can then aggregate these to determine the single similarity value for the proposed post and the segmented trending topic. A corollary of the above algorithm is that given a list of posts around a particular topic, we can rank them in the order of relevance based on their similarity scores with the segmented trending topic emotion.

Once the comparing at 407 producing a similarity score is done, the method may continue with determining 409 whether the proposed post should publish or not. This can be achieved by comparing the similarity score to a given threshold, in one embodiment. The threshold can be set, for example, based on theoretical and/or empirical data indicative of a sufficient match. As previously explained, the different thresholds can be set to rank a plurality of proposed posts, so that the “best” post or posts could be selected or otherwise known by the user. Thus, a plurality of posts can be ranked on the basis of emotion similarity with trending posts. In any case, if the similarity score exceeds that threshold for a given comparison, then the method may continue with automatically publishing 413 that post, or alternatively recommending or otherwise prompting 413 the user to publish the post. If multiple posts were provided, then a ranked listing of those posts can be displayed or otherwise provided to the user for selection. In one such example embodiment, each ranked post can be associated with a radio button or check box or other suitable UI feature, and the user can select the preferred ranked post or posts (e.g., by clicking the appropriate radio buttons or check boxes, etc) and then click a submit button UI control feature. Numerous such selection schemes will be apparent in light of this disclosure. On the other hand, if the similarity score does not exceed that threshold or otherwise indicate a sufficient match, then the method may continue with recommending or otherwise prompting 411 the user to not publish the post.

Another specific example is provided, with reference to FIGS. 4 and 5b-f. However, note that such examples are merely just a description of one possible embodiment and are not intended to be exhaustive or otherwise limit the claimed invention. Assume the proposed post P to be published is: “I am very happy with the new iphone.” The keywords identified at 401 include ‘new’ and ‘iphone’; and the topics extracted from the given ontological tree (T) at 401 include ‘Apple’ and ‘iphone’. In one example embodiment, this is accomplished using OpenCalais by Calais (http://www.opencalais.com), which automatically and rapidly creates rich semantic metadata for content. Using natural language processing, machine learning and other methods, Calais analyzes the proposed post P and finds the entities (keywords and topics) within it. The resulting tags output by Calais can then be used in determining the emotion of the post P. Further assume the target audience (P_{Target}) includes everyone of a given media outlet (e.g., a user's extended Facebook community or all readers of a given blog or some other online community of interest to the user). At 403, the post emotion is determined, with the resulting emotion histogram shown in FIG. 5b. So, the D1, D2, and D3 distance values are measured for each of the keywords identified at 401 (‘new’ and ‘iphone’) to give a measure of intensity of emotion represented in the proposed post, and these are passed to the SVM model. This model outputs the emotion values that are used to construct the histogram. For instance, in the given example scenario of FIG. 5b, the SVM model gives following scores for emotion associated with ‘new’ and ‘iphone’: Happiness=80, Admiration=65, Fear=0, Surprise=2, Sadness=0, Hatred=0, Anger=0, and Anticipation—5. As can be further seen, the emotion value score scale is normalized to 100. At 405, analysis is carried out on the trending posts in the target audience (P_{Target} Everyone) belonging to the topic: Apple iphone. The resulting aggregate emotion histogram of these trending posts (trending emotions) is shown in FIG. 5c, which can be computed in a similar fashion as the histogram of FIG. 5b. In this example case, the SVM model gives following scores for trending emotion associated with ‘new’ and ‘iphone’: Happiness=75, Admiration=70, Fear=6, Surprise=20, Sadness=0.5, Hatred=0, Anger=0, and Anticipation—12. Once these two emotion histograms (for the post emotion) and trending emotion) are computed, the degree of matching between the two emotion histograms can be computed, at 407. As previously explained, this can be accomplished using a matching table, in accordance with one embodiment. The resulting table for this particular example is shown in FIG. 5d. As can be seen, the matching table represents the extent of overlap (similarity) of post-emotions with trending emotions, wherein the overlap result is color coded with dark green representing a perfect match, yellow representing moderate match, and red to represent no-match (in a continuous gradient from red to green representing 0 to 1, as further shown in FIG. 5e, with intervening shades of lighter greens, yellows, oranges, and orangish-reds). As most of the emotions from the two histograms (FIGS. 5b and 5c) have a moderate or better match (overlap) and most of the colors are thus in the green range (greenish) and one yellow (for the primary emotion of fear), the publishing guidance to publish the post P can be made. Note that the difference threshold for color coding can be different for different emotions. For instance, in the example embodiment captured in FIGS. 5b-d, an emotion value difference of 18 for surprise is still in the green range, while an emotion value difference of 6 for fear is in the yellow range. To this end, the difference thresholds can be set as desired to increase (or decrease) sensitivity to a given emotion.

Another measure of the overlap between the two histograms (FIGS. 5b and 5c) is the cosine similarity, a similarity score between 0 and 1:

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} .$$

The cosine similarity calculation is shown in FIG. 5f. As can be seen, the cosine similarity comes out to be 0.97. Hence, this also suggests that the post can be published. In one such embodiment, assume the publishing threshold is a similarity score of 0.90 or higher.

User Interface

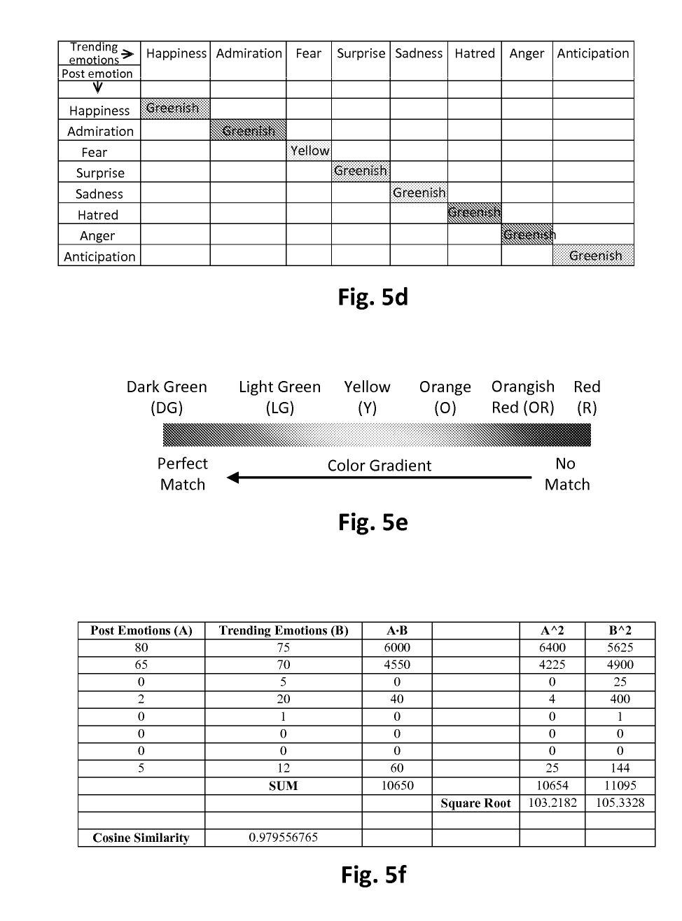

FIGS. 6a-b illustrate a client-side user interface (UI) configured for use with a post moderating methodology, in accordance with an embodiment of the present invention. As can be seen in FIG. 6a, the UI can be part of a content publishing app but may also be a stand-alone application. In this example case, the UI includes main menu that may include access to various functions (e.g., save, open, font selection, etc) and a posting field in which a proposed post has been provided. A post UI control feature is provided for the user to select (e.g., via a mouse click or tap), so as to allow the proposed post to be submitted for publication via some online publishing service (e.g., social network, blog, etc). Also shown is a bulletin board window showing various recent posts of other users (Poster-1, Poster-2, etc), included in the existing published content. As will be appreciated, this already published content can be, for instance, like the existing published content 105 of FIG. 1 or the data corpus of trending entities 507 of FIG. 5.

As can be further seen in FIG. 6b, once the user selects or otherwise engages the post UI control feature to publish the proposed post, a pop-up window appears with a publishing recommendation with respect to that post. In this example case, the pop-up window includes a message as to how well the emotion of the proposed post matches the currently trending emotion associated with the topic of that post for a given audience. The user (e.g., member of social network, blogger or blog reader, marketer, content publisher, etc) then has the opportunity to either publish the post by selecting the ‘yes’ control feature or to not publish the post by selecting the ‘no’ control feature.

As will be appreciated in light of this disclosure, the trending emotion for a given post topic for a given target audience will play a significant role in determining whether the post should be published or not. For example, a Red Sox baseball fan posting supportive Red Sox content to a publishing venue dominated by loyal Red Sox fans will likely be received with great enthusiasm. However, that same post will likely not be received well when posting to a publishing venue dominated by loyal Cardinal fans. As will be further appreciated, the publishing guidance may be presented in a number of ways, whether it be given in real-time as the user types the post, or after the user submits the post but prior to releasing the post for actual publication. Likewise, the publishing guidance may be indicated with textual guidance and/or a non-textual visual indicator.

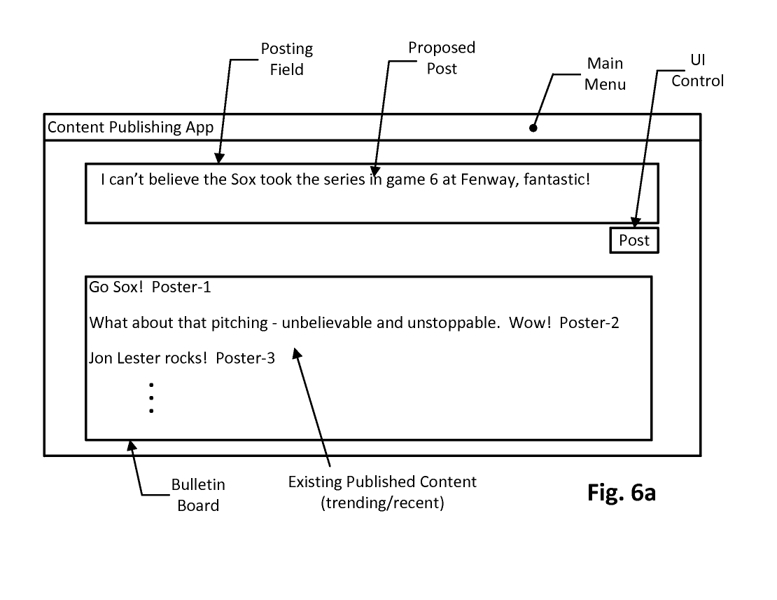

One example where publishing guidance in the form of a non-textual visual indicator is provided in real-time as the user enters the proposed post into the posting field example is shown in FIG. 7. In this example case, the proposed post is determined to be supportive and enthusiastic about the Red Sox winning the World Series (e.g., based on “Red Sox” and the exclamation of “fantastic”, and the phrase “took the Series” being synonymous with winning, as determined by the post analyzer 301). However, the trending emotion of existing content within the target audience for the proposed post topic of “Red Sox” is determined to be anger and disappointment and otherwise adversarial with respect to the Red Sox winning the World Series (e.g., based on the proximity of “Boo” to “Sox” and the exclamation of “Go Cardinals” and the use of “Cardinals” in the same sentence as the phrase “did very well”, as determined by the topic-segment analyzer 303). So, as the user types the proposed post and the analysis of that post is executed, the real-time suggestion meter moves toward the ‘Don't Post!’ end of the meter and away from the ‘Post!’ end of the meter.

Numerous embodiments will be apparent, and features described herein can be combined in any number of configurations. One example embodiment of the present invention provides a computer implemented method. The method includes determining a topic of a given post proposed for publishing to an online community including a target audience, determining emotion of the post, and determining trending emotion within the target audience for the topic of the post. The method continues with comparing the post emotion with the trending emotion of the target audience, and determining post publishing guidance based on the comparing. In some cases, comparing the post emotion with the trending emotion of the target audience includes comparing two emotion vectors. In some cases, comparing the post emotion with the trending emotion of the target audience includes determining similarity between two emotion histograms using a vector similarity measure. In one such case, the vector similarity measure includes cosine similarity. In some cases, determining post publishing guidance based on the comparing is carried out in real-time as the proposed post is created. In some cases, the post publishing guidance is provided automatically in response to an attempt to publish the proposed post. In some cases, the post publishing guidance includes a recommendation to publish or not publish the post. In some cases, the post publishing guidance includes a recommendation to modify the post. In some cases, the method is carried out for each of a plurality of given posts provided by one or more users, and further includes ranking each of the proposed posts on the basis of emotion similarity as indicated by the comparing. In some cases, in response to the post publishing guidance being above a given threshold, the method further includes automatically publishing the post in response to an attempt to publish the proposed post. In some cases, the post emotion is represented by a combination of base emotions detected in the post. In some cases, the trending emotion within the target audience for the topic is represented by combination of base emotions detected in existing content associated with the target audience. In some cases, each of the post emotion and the trending emotion within the target audience for the topic is represented by at least two emotions detected in the post.

Another embodiment of the present invention provides a computing system. In this example case, the system includes a post analyzer module configured to determine a topic of a given post proposed for publishing to an online community including a target audience, and to determine emotion of the post, and a topic-segment analyzer module configured to determine trending emotion within the target audience for the topic of the post. The system further includes an emotion comparator module configured to compare the post emotion with the trending emotion of the target audience, and to determine post publishing guidance based on the comparing. In some cases, the emotion comparator module is configured to compare the post emotion with the trending emotion of the target audience using emotion vectors. In some cases, the emotion comparator module is configured to compare the post emotion with the trending emotion of the target audience includes by determining similarity between two emotion histograms using a vector similarity measure. In some cases, the post publishing guidance is provided automatically in response to an attempt to publish the proposed post. In some cases, in response to the post publishing guidance being above a given threshold, the emotion comparator module is further configured to automatically publish the post in response to an attempt to publish the proposed post. In some cases, each of the post emotion and the trending emotion within the target audience for the topic is represented by at least two distinct emotions detected in the post.

Another embodiment of the present invention provides a non-transient computer program product encoded with instructions that when executed by one or more processors causes a process to be carried out. The computer program product may be, for instance, a hard drive, server, disc, thumb-drive, or other suitable non-transient memory or set of memories). In one example case, the process includes determining a topic of a given post proposed for publishing to an online community including a target audience, determining emotion of the post, and determining trending emotion within the target audience for the topic of the post. The process further includes comparing the post emotion with the trending emotion of the target audience, and determining post publishing guidance based on the comparing. In one such case, each of the post emotion and the trending emotion within the target audience for the topic is represented by at least two distinct emotions detected in the post (such as a histogram of primary emotions, such as the examples shown in FIGS. 5b-c).

The foregoing description of example embodiments of the invention has been presented for the purposes of illustration and description. It is not intended to be exhaustive or to limit the invention to the precise forms disclosed. Many modifications and variations are possible in light of this disclosure. It is intended that the scope of the invention be limited not by this detailed description, but rather by the claims appended hereto.

What is claimed is:

1. A computer implemented method, comprising:
determining a topic of a given post proposed for publishing to an online community including a target audience;
determining emotion of the post;
determining trending emotion within the target audience for the topic of the post;
comparing the post emotion with the trending emotion of the target audience; and
determining post publishing guidance based on the comparing.

2. The method of claim 1 wherein comparing the post emotion with the trending emotion of the target audience includes comparing two emotion vectors.

3. The method of claim 1 wherein comparing the post emotion with the trending emotion of the target audience includes determining similarity between two emotion histograms using a vector similarity measure.

4. The method of claim 3 wherein the vector similarity measure includes cosine similarity.

5. The method of claim 1 wherein determining post publishing guidance based on the comparing is carried out in real-time as the proposed post is created.

6. The method of claim 1 wherein the post publishing guidance is provided automatically in response to an attempt to publish the proposed post.

7. The method of claim 1 wherein the post publishing guidance includes a recommendation to publish or not publish the post.

8. The method of claim 1 wherein the post publishing guidance includes a recommendation to modify the post.

9. The method of claim 1 wherein the method is carried out for each of a plurality of given posts provided by one or more users, and further includes ranking each of the proposed posts on the basis of emotion similarity as indicated by the comparing.

10. The method of claim 1 wherein in response to the post publishing guidance being above a given threshold, the method further includes automatically publishing the post in response to an attempt to publish the proposed post.

11. The method of claim 1 wherein the post emotion is represented by a combination of base emotions detected in the post.

12. The method of claim 1 wherein the trending emotion within the target audience for the topic is represented by combination of base emotions detected in existing content associated with the target audience.

13. The method of claim 1 wherein each of the post emotion and the trending emotion within the target audience for the topic is represented by at least two emotions detected in the post.

14. A computing system, comprising:
a post analyzer module configured to determine a topic of a given post proposed for publishing to an online community including a target audience, and to determine emotion of the post;
a topic-segment analyzer module configured to determine trending emotion within the target audience for the topic of the post; and
an emotion comparator module configured to compare the post emotion with the trending emotion of the target audience, and to determine post publishing guidance based on the comparing.

15. The system of claim 14 wherein the emotion comparator module is configured to compare the post emotion with the trending emotion of the target audience using emotion vectors.

16. The system of claim 14 wherein the emotion comparator module is configured to compare the post emotion with the trending emotion of the target audience includes by determining similarity between two emotion histograms using a vector similarity measure.

17. The system of claim 14 wherein the post publishing guidance is provided automatically in response to an attempt to publish the proposed post.

18. The system of claim 14 wherein in response to the post publishing guidance being above a given threshold, the emotion comparator module is further configured to automatically publish the post in response to an attempt to publish the proposed post.

19. The system of claim 14 wherein each of the post emotion and the trending emotion within the target audience for the topic is represented by at least two distinct emotions detected in the post.

20. A non-transient computer program product encoded with instructions that when executed by one or more processors causes a process to be carried out, the process comprising:
determining a topic of a given post proposed for publishing to an online community including a target audience;
determining emotion of the post;
determining trending emotion within the target audience for the topic of the post;
comparing the post emotion with the trending emotion of the target audience; and
determining post publishing guidance based on the comparing;
wherein each of the post emotion and the trending emotion within the target audience for the topic is represented by at least two distinct emotions detected in the post.
